(19) United States
(12) Patent Application Publication
(10) Pub. No.: US 2009/0072937 A1
(43) Pub. Date: Mar. 19, 2009

(54) Steel pipe demagnetizing tool

(76) Inventor: John Holley, Morehead, KY (US)

Correspondence Address: JOHN W. HOLLEY, 20 KOLB DRIVE, MOREHEAD, KY, 40351, US

(21) Appl. No.: 10/997,001

(22) Filed: Jun. 5, 2006

(51) Int. Cl. H01F 13/00

(52) U.S. Cl. 335/284

(57) ABSTRACT

A system for negating remnant magnetic fields in a weld joint between two work pieces or pipes The electromagnet structure are formed around the pipe with surfaces that provide a substantial area for magnetic flux coupling with each repair area on either side of the weld joint.

### CROSS-REFERENCE TO RELATED APPLICATION

N/A

### STATEMENT REGARDING FEDERALLY SPONSORED RESEARCH OR DEVELOPMENT

Not applicable

### REFERENCE TO SEQUENCE LISTING

Not applicable

### FIELD OF THE INVENTION

This invention relates to welding, and more particularly to apparatus and methods for removing magnetic fields for the purpose of welding steel pipe. Specifically, such improvement is accomplished by removing remnant magnetic fields in the area being welded.

### BACKGROUND OF THE INVENTION

A long recognized problem in Pipeline Construction Maintenance welding, specifically electric arc welding, is magnetism. This problem often results in a poor weld due to the varying, nonuniform blow of the arc or an inability to weld at all. A variety of methods and apparatus have been devised to control arc stray. U.S. Pat. No. 1,947,077 to Chapman, for example, utilizes an electric current through a backing strip or U-shaped element that creates a magnetic field. This field coacts with the field set up by the welding electrode to “blow” the arc forward in advance of the electrode as it moves along the seam. U.S. Pat. No. 388,245 to Bernardos utilizes an electromagnet located beneath the plates to be welded to influence the electric arc U.S. Pat. No. 2,773,969 to Gunther utilizes a “magnetic girdle” for use with pipelines. U.S. Pat. No. 2,472,851 to Landis utilizes a plurality of coils concentric with an annular electrode to control arc movement in a circular path. U.S. Pat. No. 2,475,183 to Gibson includes a magnet with a pole piece extension to deflect the arc toward the pole piece and thus control its direction during welding. U.S. Pat. No. 3,584,181 to Nemote includes a magnetizing coil that surrounds a rod-shaped workpiece. The magnetizing coil is intended to overcome the circular field created by welding current. Each of these prior art apparatus and methods attempts to control the direction of arc movement by imposing a magnetic field upon it. Such apparatus and methods have been ineffective because of the difficulty in determining and maintaining the proper magnitude and direction of the magnetic field required to achieve the desired effect on the arc. Often the actual effect of such devices is to exacerbate the problem of arc stray.

U.S. Pat. No. 2,994,763 to Schultz and U.S. Pat. No. 3,626,145 to Jackson attempt to overcome the varying magnetic effects by monitoring certain parameters. Schultz uses a pair of photoelectric cells to monitor the position of the arc and an electromagnet that is responsive to the sensed arc position. The electromagnet is intended to produce a force field that compensates for detected drift. Jackson uses a Hall-effect probe mounted immediately ahead of the arc to detect the magnetic environment about the arc. A detector and control circuit is intended to receive signals from the probe and control the current to an electromagnet to set up a “preselected and optimized” magnetic environment. The drawback to such systems is the inability to determine and control an optimum magnetic environment. Systems that attempt to manipulate the arc path with external magnetic fields have been ineffective.

Additional apparatus and methods have been devised for providing a better weld through the use of a controlled magnetic field. Specifically, U.S. Pat. No. 4,107,503 to Koshiya and U.S. Pat. No. 4,716,536 to Blakeley seek to overcome residual or remnant magnetic fields that are found in ferritic materials to be welded. Koshiya is directed to a system to counter magnetic fields created by prior welding operations. In Koshiya, in order to reduce arc blow occurring during welding of the outside of a pipe blank, the direct current in the line feeding the consumable electrode is reversed from that supplied during welding on the inside of the pipe blank. The same magnitude of current is used for welding and for eliminating residual magnetism. This method is often ineffective because the residual magnetism in the pipe blank is not always caused solely by the prior welding operation and simply reversing the current can exacerbate arc blow. Further this system is only applicable to situations where a prior welding operation has been performed and the magnitude and direction of the welding current are known. Blakeley attempts to remove remnant magnetic fields by placing loops of coils on the plates to be welded adjacent to the weld joint. Current is passed through the coils in a direction and magnitude sufficient to counter the remnant magnetic field as measured by a gaussmeter. However, laying of coils in the area of welding can be cumbersome. Further, proper selection of the placement and exact alignment of coils to achieve the desired magnetic effect may be difficult in actual practice.

### SUMMARY OF THE INVENTION

The present device overcomes the disadvantages of the prior art by providing an effective and easy to use device for negating or countering remnant magnetic fields in the area of pipe to be welded.

The current invention or steel pipe demagnetizing tool is built and designed in pipeline construction maintenance for the purpose of removing magnetism. Magnetism is introduced into steel pipe when an inline inspection tool is passed through the pipeline introducing magnetism into the steel pipe. This magnetism leaves it virtually non-weldable during the replacement phase of pipeline rehabilitation. The current device is designed for use on all steel pipeline facilities from two inches to forty eight inches, in outside diameter.

After the defective section of pipe has been removed the present invention or steel pipe demagnetizing tool is placed (slid onto) one end of the existing pipe where the tie-in weld is to be performed. With the end of the unit with the demagnetizing cable facing the open end of the pipeline, an electric current is introduced into the Tool. Connecting the positive and negative leads of a D.C. welding machine to the Demagnetizing Cables on the Tool for two to five seconds does this. The surge of current through the Demagnetizing Tool removes from 92% to 100% of the magnetism from the weld area making it possible to make a successful weld without the problem of magnetism. The process is duplicated at the other tie-in end of the anomaly to complete the demagnetizing process for this particular repair area.

This system provides the operator with a simple and highly effective way of eliminating remnant magnetic fields in the local area or pipe to be welded. The operator can visually observe the effects of adjustment to the pipe. This greatly eliminates arc blow, rough weld appearance and poor weld fusion without the complex, cumbersome and often ineffective apparatus of the prior art. The system is effective in counteracting magnetic fields.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

It is therefore an object of the present invention to provide a steel pipe demagnetizing tool apparatus and method which has many of the advantages of the closures mentioned heretofore and many novel features that result in a steel pipe demagnetizing tool which is not anticipated, rendered obvious, suggested, or even implied by any of the prior art tool guides, either alone or in any combination thereof.

It is another object of the present invention to provide a steel pipe demagnetizing tool which may be easily and efficiently manufactured and marketed.

It is a further object of the present invention to provide a steel pipe demagnetizing tool which is of a durable and reliable construction.

An even further object of the present invention is to provide a steel pipe demagnetizing tool which is susceptible of a low cost of manufacture with regard to both materials and labor, and which accordingly is then susceptible of low prices of sale to the consuming public, thereby making such steel pipe demagnetizing tool economically available to the buying public.

Still yet another object of the present invention is to provide a steel pipe demagnetizing tool which provides in the apparatuses and methods of the prior art some of the advantages thereof, while simultaneously overcoming some of the disadvantages normally associated therewith.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

FIG. 1 is a perspective view of the steel pipe demagnetizing tool system of the present invention showing the electromagnet and controller.

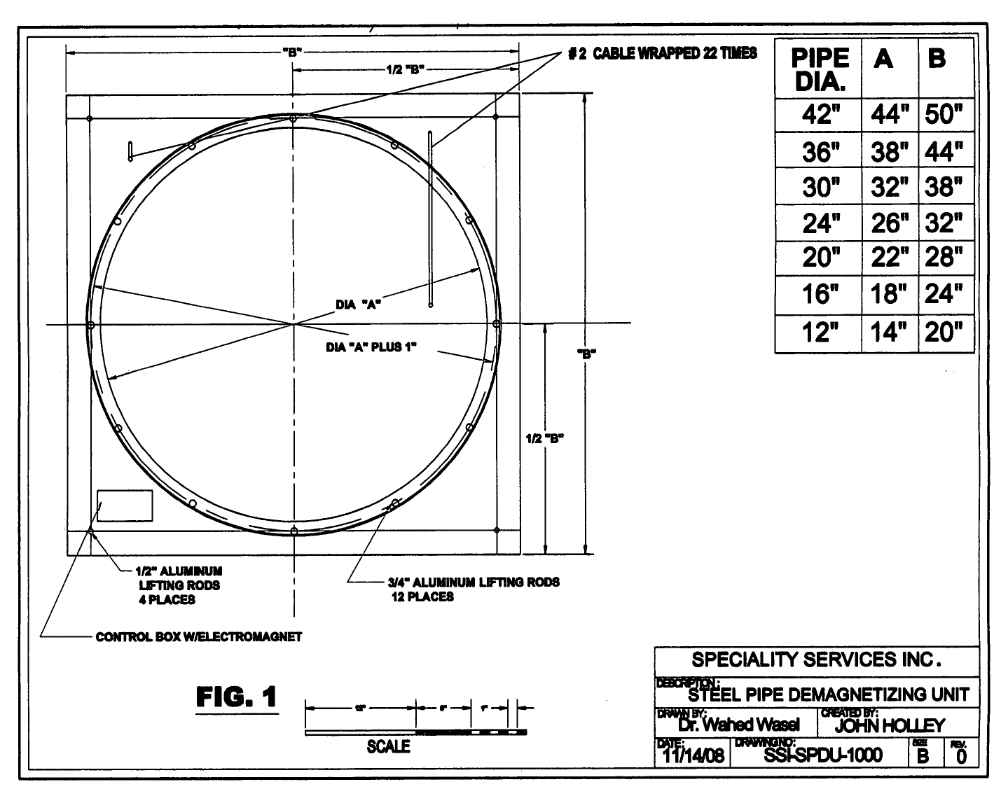

FIG. 2 is a front view of the steel pipe demagnetizing tool of the present invention shown in partial cross-section.

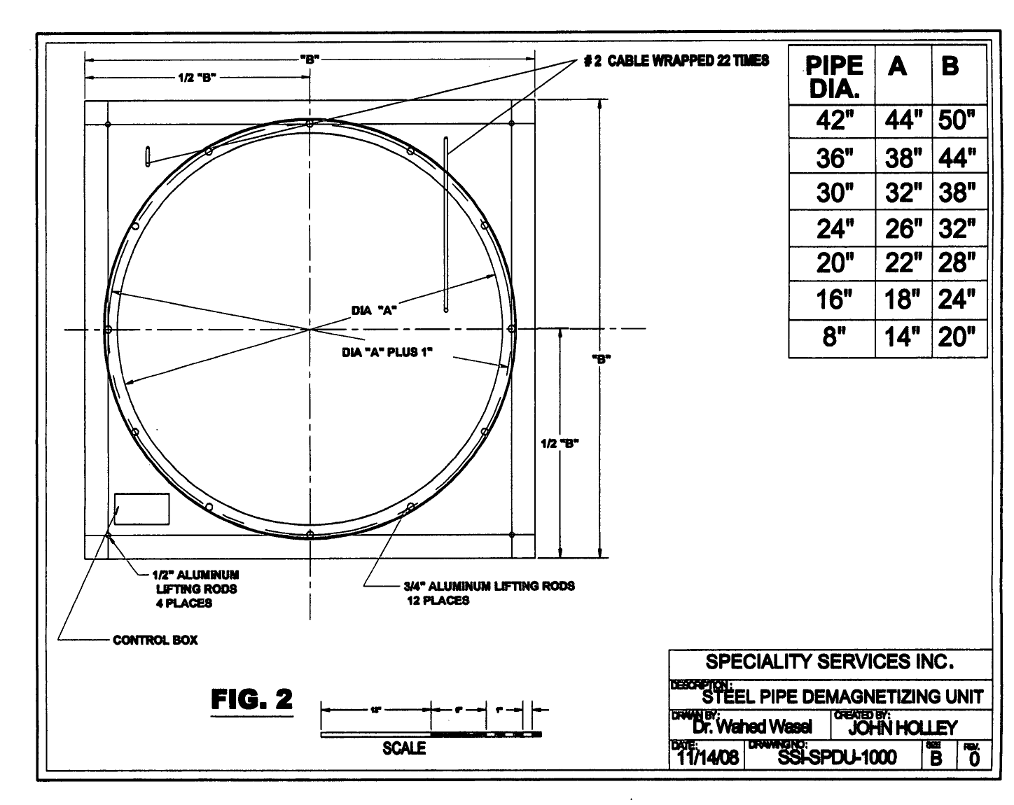

FIG. 3 is a perspective view of the steel pipe demagnetizing tool assembly right side

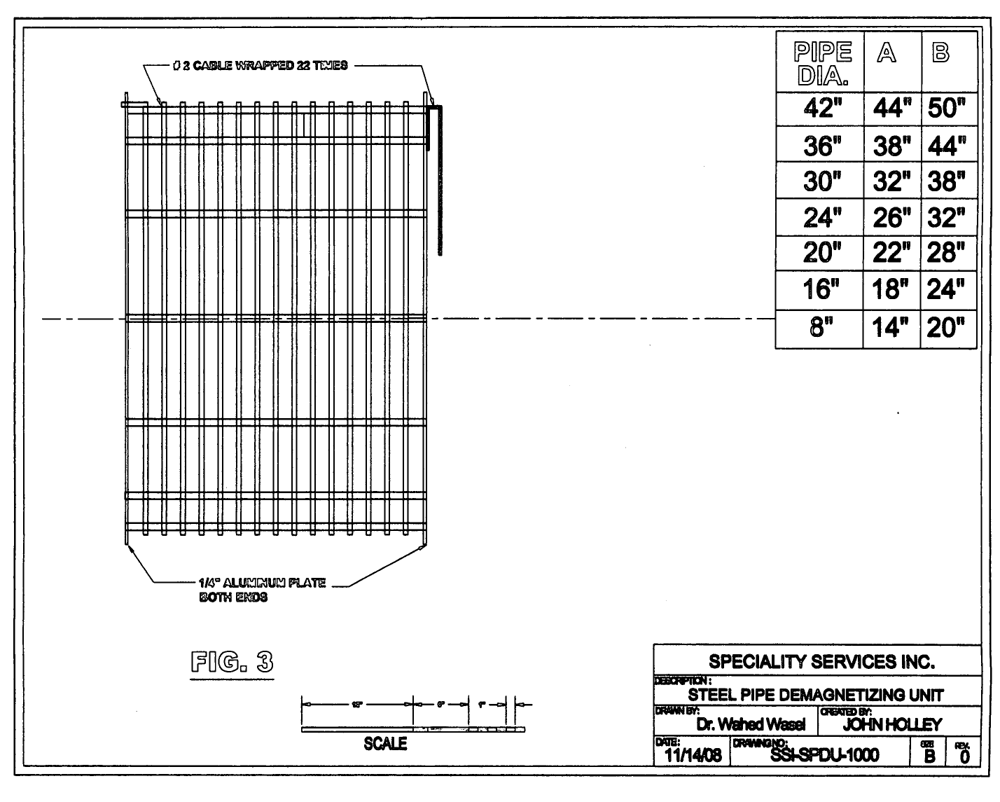

FIG. 4 is a perspective view of the steel pipe demagnetizing tool assembly left side.

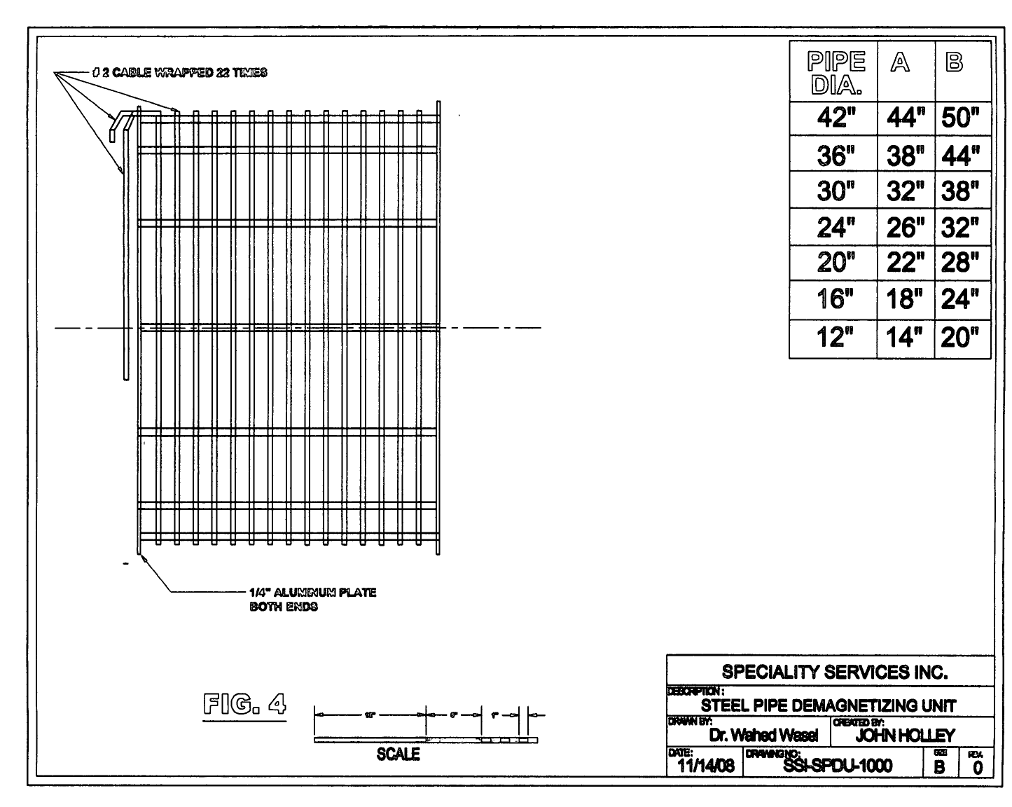

FIG. 5 is a front view of an embodiment of the steel pipe demagnetizing tool of the present invention.

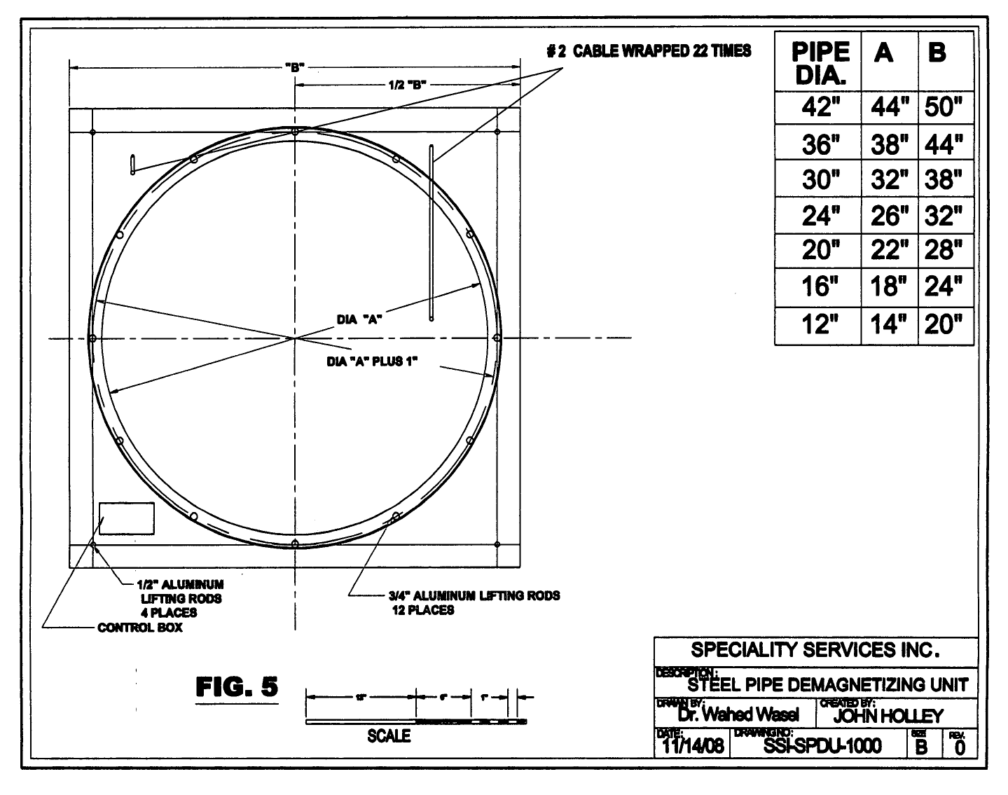

FIG. 6 is an elevational view, partly in cross-section showing the placement relative to two pieces to be welded.

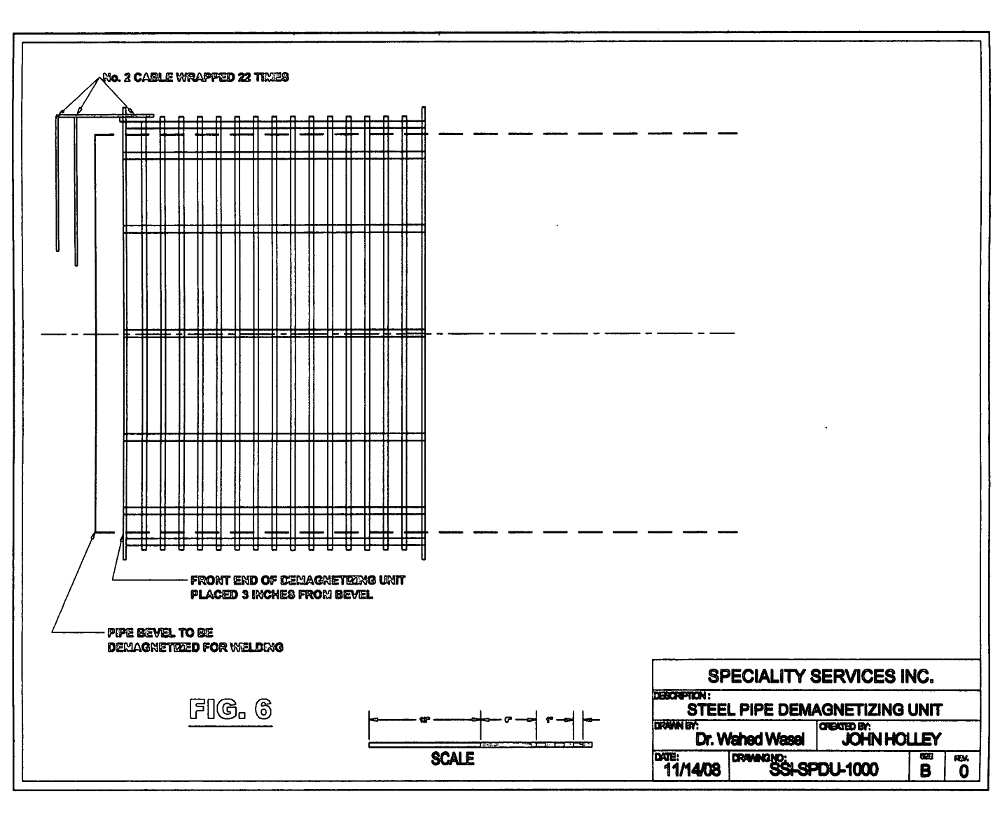

What is claimed as being new and desired to be protected is as follows:

We claim:

1. A steel pipe demagnetizing tool for removing magnetism from transmission pipes so that welding repairs can take place.

2. A steel pipe demagnetizing tool according to claim 1 wherein the tool is portable and easy to transport on and off site.

3. A steel pipe demagnetizing tool according to claim 1 wherein the device uses DC power from the welding unit.

4. A steel pipe demagnetizing tool according to claim 1 wherein the device relies on existing power supplies located on the job or welding site.

5. A steel pipe demagnetizing tool according to claim 1 wherein the device does not require continual maintenance.

6. A steel pipe demagnetizing tool according to claim 1 wherein the device can be used on steel pipe ranging in outside diameter from two (2) inches to forty eight (48) inches.

7. A steel pipe demagnetizing tool according to claim 1 wherein the device is slid over the pipe to be repaired.
